(19) United States
(12) Patent Application Publication
(10) Pub. No.: US 2014/0017374 A1
(43) Pub. Date: Jan. 16, 2014

(54) AVOCADO TOOL

(71) Applicant: Progressive International Corporation, Kent, WA (US)

(72) Inventor: Justin Bagley, Seattle, WA (US)

(21) Appl. No.: 13/939,449

(22) Filed: Jul. 11, 2013

Related U.S. Application Data
(60) Provisional application No. 61/670,544, filed on Jul. 11, 2012.

(51) Int. Cl. A47J 25/00

(52) U.S. Cl. CPC A47J 25/00
USPC 426/482; 99/537

(57) ABSTRACT

An avocado tool includes a handle having a knife blade attached at one end of the handle and a plurality of spikes formed on the opposite end of the handle. A sheath is configured to receive the blade for storage and therefore includes an opening at one end. The opposite end of the sheath is shaped in the form of a spatula for use in scooping avocado to separate the fruit from the blade.

### PRIORITY CLAIM

This application claims the benefit of provisional application No. 61/670,544 filed Jul. 11, 2012, the contents of which are incorporated by reference.

### FIELD OF THE INVENTION

This invention generally relates to devices for separating the flesh of an avocado from its skin and pit.

### BACKGROUND OF THE INVENTION

Accessing the fruit from an avocado typically involves three steps, including slicing the avocado in half, removing the pit, and then separating the fruit from the peel. These steps are commonly performed with multiple tools, including a knife to slice open the avocado and a spoon to remove the fruit from the peel. Many cooks also use a knife to remove the pit, and because the pit is very slippery and the avocado is typically quite soft, removing the pit can be a tricky and sometimes dangerous process. In addition, the typical spoon used to remove the fruit from the peel is not shaped to closely match the shape of the avocado, and as a result it may leave some fruit clinging to the skin. Existing products such as avocado slicers can work well to simultaneously slice the fruit and remove it from the skin, but do not work to slice the avocado in half and remove the pit.

### SUMMARY OF THE INVENTION

An exemplary avocado tool includes a handle having a knife blade attached at one end of the handle and a plurality of spikes formed on the opposite end of the handle. A sheath is configured to receive the blade for storage and therefore includes an opening at one end. The opposite end of the sheath is shaped in the form of a spatula for use in scooping avocado to separate the fruit from the blade.

### BRIEF DESCRIPTION OF THE DRAWINGS

Preferred and alternative examples of the present invention are described in detail below with reference to the following drawings:

FIG. 1 is a perspective view of a preferred avocado slicer, shown with the knife stored within the sheath.

FIG. 2 is a top view of a preferred knife.

FIG. 3 is an exploded view of the knife of FIG. 2.

FIG. 4 is a top view of a preferred sheath and spatula.

FIG. 5 is an exploded view of the sheath and spatula of FIGS. 4.

### DETAILED DESCRIPTION OF THE PREFERRED EMBODIMENT

A preferred avocado tool 100 includes a knife having a handle 40 and a knife blade 30 attached at one end of the handle, with a plurality of spikes 60 formed in a cavity 50 on the opposite end of the handle. A sheath 20 is configured to receive the blade for storage and therefore includes an opening 22 at one end. The opposite end of the sheath is shaped in the form of a spatula 10 for use in scooping avocado to separate the fruit from the blade.

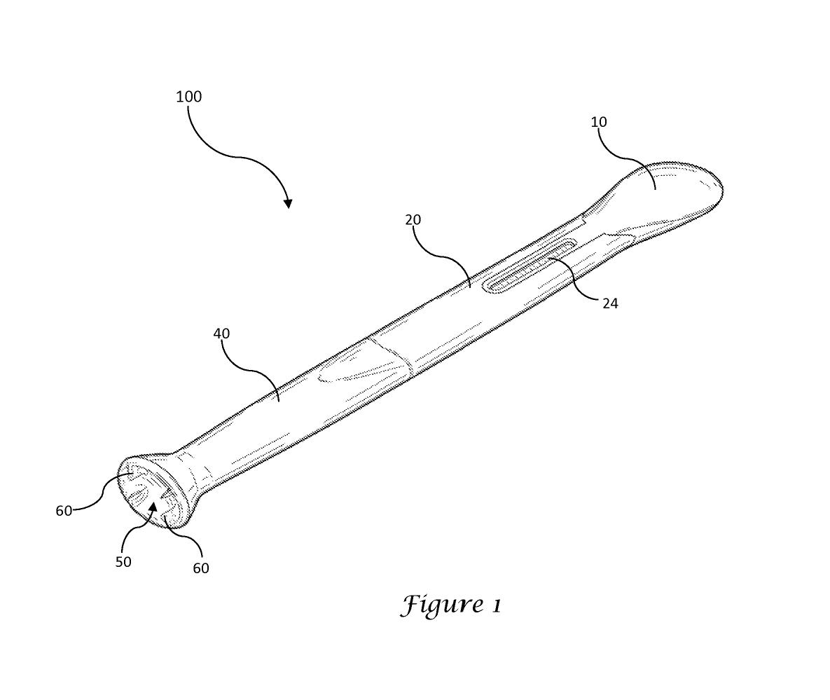

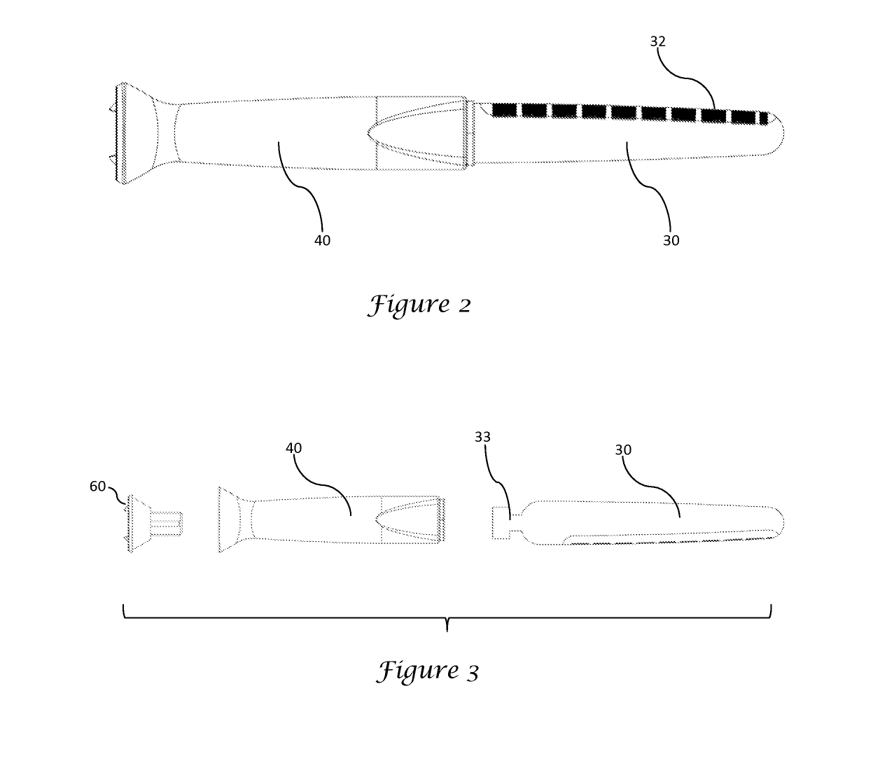

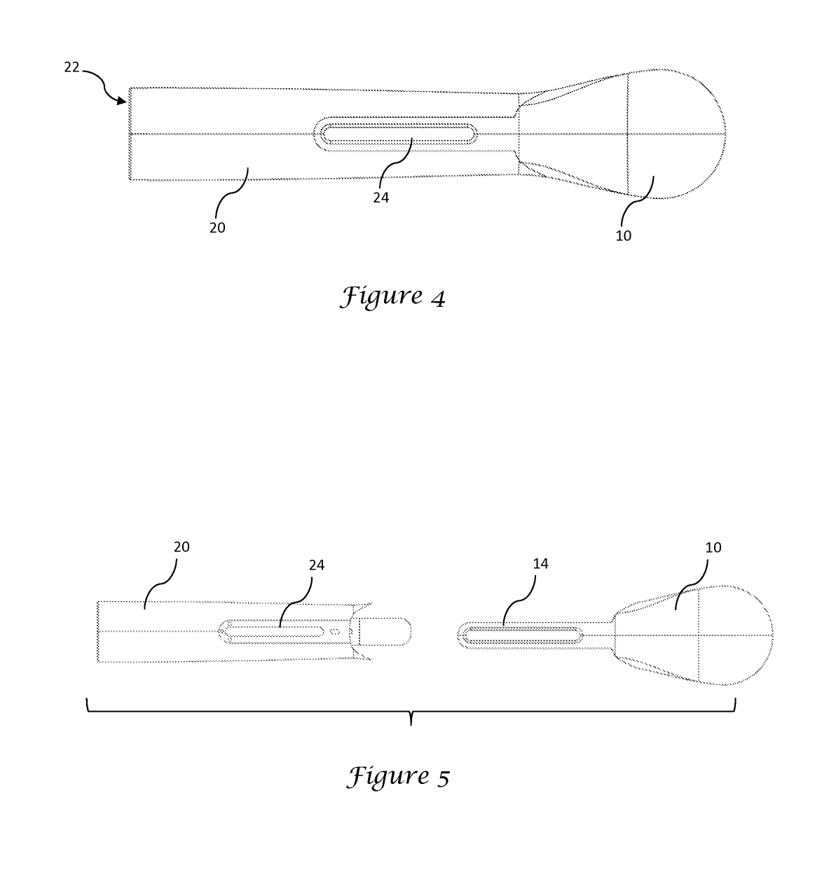

In the perspective view of FIG. 1, the knife is housed within the sheath, and the knife blade is partially visible within the sheath through an opening 24 formed on an intermediate portion of the sheath. The opening facilitates cleaning of bits of avocado that might otherwise be trapped within the sheath when the knife is inserted.

The handle is preferably formed from a plastic material but may be formed from any material suitable for a knife handle, such as wood, ceramic, metal or other materials. The handle optionally may be coated or over-molded with a thermoplastic elastomer or other resilient material to provide a better grip.

The knife blade extends away from a first end of the handle. In some versions of the invention the handle and blade are integrally formed from the same material. In other versions, the blade is formed from a first material such as metal and permanently attached to the handle, which may be formed from a second material. In the version as illustrated, the blade 30 includes a shank 33 that is received within a recess formed in the handle 40 to retain the knife within the handle.

The blade may be formed in a variety of ways, and in a first embodiment the blade includes a sharpened edge 32 having a serrated surface. The inclusion of a serrated knife edge may allow for a better ability to cut through the skin of the avocado. In other versions the blade is not serrated.

At a second end of the handle, opposite the blade, one or more spikes 60 are provided. The spikes are configured to be able to at least partially pierce the pit of an avocado for removal. Most preferably, the second end of the handle includes a recessed or concave region 50 to receive at least a portion of a rounded surface of an avocado pit.

In one version, four spikes are provided at a distal end of the handle, with the base of the spikes being positioned within the recessed portion and the relatively sharp tips extending out of the recessed region. As illustrated, the four spikes are positioned such that they are evenly spaced about the perimeter of the rounded or circular second end of the handle, each of the spikes having a sharpened tip that is angled slightly toward the center, and therefore pointed at least slightly toward the central space between the set of four spikes. This orientation allows the spikes to pierce the pit of the avocado and provides an improved ability to retain the pit in its grip for removal from the avocado fruit.

The spikes are preferably not circular in cross-section, but rather are configured to have a width extending along a radius from the center of the depressed region outward. This width in the shape of the spike allows the spike to retain a firmer grip on the pit as the handle is twisted in order to twist the pit for removal from the fruit.

The sheath includes an elongated section having an interior cavity sized to receive the blade. In the illustrated version, the sheath includes an opening 24 providing a window through which the blade can be seen when it is sheathed. The opening as shown is elongated, running along a side of the sheath. The opening further improves the ability of the sheath to be cleaned in the event bits of avocado are still on the knife when inserted into the sheath.

At the distal end of the sheath a spatula 10 is formed. Most preferably the spatula is flat, though in some versions it has a shallow convex curvature forming a very shallow raised surface rather than being shaped as a flat spatula. In a preferred version the spatula is formed from a resilient or at least semi-flexible material such as a food grade silicone to better enable the spatula to flex somewhat and adapt to the shape of the avocado skin for better removal of the fruit. In some versions, however, the spatula may be formed from a rigid material. In the exploded view of FIG. 5, a preferred sheath and spatula is formed in two pieces, including a main sheath portion 20 and a spatula portion 10, with the sheath portion begin rigid and the spatula portion being flexible. Optionally, as shown in FIG. 5, the flexible portion includes an extension 14 that surrounds the opening 24 in order to provide a better adhesion of the spatula portion onto the sheath portion.

In use, the blade is removed from the sheath and used to slice the avocado in half. For safety, the blade is then replaced in the sheath. The spikes at the second end of the handle are then pressed into the pit and, after insertion, the handle (and therefore the spikes) is rotated to twist the pit away from the fruit. If desired, the blade can be used to slice the avocado fruit while still in the peel. Whether sliced or not, the spatula is then used to separate the fruit from the peel by inserting the spatula into the avocado at the interface between the fruit and the peel and then sliding it through the avocado along the interface until the fruit is removed.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An avocado tool, comprising:
a knife having a handle and a blade;
a sheath configured to receive the blade for storage within the sheath; and
a spatula formed on an end of the sheath.

2. The avocado tool of claim 1, further comprising a spike formed on the handle.

3. The avocado tool of claim 2, wherein the handle further comprises a recessed portion formed on the end of the handle and the spike comprises a plurality of spikes, the plurality of spikes being formed on the end of the handle.

4. The avocado tool of claim 3, wherein the plurality of spikes is secured within and extend beyond the recessed portion of the handle.

5. The avocado tool of claim 4, wherein the spatula is formed from a resilient material.

6. The avocado tool of claim 5, wherein the sheath is formed from a rigid material.

7. The avocado tool of claim 6, wherein the sheath further comprises an opening formed on a sidewall of the sheath, whereby a portion of the blade is visible through the opening when the blade is stored within the sheath.

8. A method for removing fruit of an avocado, comprising:
providing an avocado tool in accordance with claim 2;
slicing the avocado in half using the knife;
removing a pit of the avocado using the spike; and
separating a peel of the avocado from the fruit using the spatula.

9. The method of claim 8, wherein the handle further comprises a recessed portion formed on the end of the handle and the spike comprises a plurality of spikes, the plurality of spikes being formed on the end of the handle.

10. The method of claim 9, further comprising the step of inserting the blade of the knife into the sheath before removing the pit.

11. An avocado tool, comprising:
a knife having a handle and a blade extending from a distal end of the handle, the handle having a plurality of spikes formed on a proximal end of the handle;
a sheath configured to receive the blade for storage within the sheath, the sheath being formed from a first rigid material; and
a spatula formed on an end of the sheath, the spatula being formed from a second flexible material.

12. The avocado tool of claim 11, wherein the proximal end of the handle is flared outwardly and further comprises an internal recessed region, the plurality of spikes being formed about the recessed region and having sharpened points oriented inward toward a central portion of the recessed region.

13. The avocado tool of claim 11, wherein the proximal end of the handle further comprises a recessed region, the plurality of spikes being secured with the recessed region and extending out of recessed region.
